(19) United States
(12) Patent Application Publication
(10) Pub. No.: US 2026/0348207 A1
(43) Pub. Date: Nov. 5, 2026

(54) TAILGATE OPENING/CLOSING ADJUSTMENT DEVICE FOR VEHICLE

(71) Applicants: HYUNDAI MOTOR COMPANY, Seoul (KR); Kia Corporation, Seoul (KR); ILJIN.CO.LTD., Gyeongju-si (KR)

(72) Inventors: Gi Ho KWON, Hwaseong-si (KR); Jae Han PARK, Hwaseong-si (KR); Jun Yong SEO, Seoul (KR); Heung Tae KIM, Seoul (KR)

(21) Appl. No.: 19/467,157

(22) Filed: Feb. 2, 2026

(30) Foreign Application Priority Data
Apr. 30, 2025 (KR) 10-2025-0056826

(51) Int. Cl. E05C 17/20; B60J 5/10; E05C 17/08

(52) U.S. Cl. CPC E05C 17/203; B60J 5/108; E05C 17/08

(57) ABSTRACT

A tailgate opening/closing adjustment device for a vehicle that adjusts the opening angle of a tailgate rotatably mounted on a rear vehicle body, the tailgate opening/closing adjustment device includes a checker arm including a locking pin and being installed so as to be slidable along the rotation trajectory of the tailgate on a checker mounting member mounted on the rear vehicle body, a checker holder mounted on the tailgate, and a checker lever pivotally installed on the checker holder to selectively lock and unlock the locking pin.

### CROSS-REFERENCE TO RELATED APPLICATION

This application claims the benefit of priority to Korean Patent Application No. 10-2025-0056826 filed in the Korean Intellectual Property Office on Apr. 30, 2025, the entire contents of which are incorporated herein by reference.

### TECHNICAL FIELD

The disclosed example relates to a tailgate opening/closing adjustment device for a vehicle, and more particularly, the present disclosure relates to a tailgate opening/closing adjustment device for a vehicle adapted to adjust the opening and closing of a swing tailgate mounted at the rear of a van vehicle.

### BACKGROUND

The matters described in this Background section are only for enhancement of understanding of the background of the disclosure, and should not be taken as acknowledgment that they correspond to prior art already known to those skilled in the art.

A van vehicle may be a multi-purpose vehicle designed to carry more people or cargo than a passenger vehicle. These van vehicles may be used for various purposes such as transporting occupants, carrying cargo, or camping due to their wide vehicle interior space and various seating arrangements. Minivans, which combine the comfort of a passenger vehicle with the versatility of an SUV, may be used.

For example, a van vehicle may have a box-shaped vehicle body with a cabin in the front and a cargo room in the rear. At the rear of this type of van vehicle, a tailgate may be mounted as a cargo door to open and close the cargo room.

The tailgate may, in one example, be a twin swing tailgate. The twin swing tailgate may be rotatably mounted on both rear pillars at the rear of the vehicle body via hinges.

The twin swing tailgate (hereinafter, for convenience, referred to as the tailgate) may be maintained in a predetermined position along the opening/closing path permitted by the hinge. The rear vehicle body (e.g., both rear pillars) and the tailgate are connected via checkers.

A checker may adjust the opening angle of the tailgate (e.g., a 90° single-stage opening angle and a 180° double-stage opening angle). Such checkers have a checker arm that is mounted on one of the rear vehicle body and tailgate, and a checker assembly that is mounted on the other.

The checker arm may be provided in a curved shape to slide along the rotation trajectory of the tailgate. The checker assembly may be locked or unlocked with the checker arm depending on the opening angle of the tailgate.

However, when the tailgate is opened at a single-stage opening angle, the checker arm may be unintentionally unlocked from the checker assembly by the external force as an external force is applied in the opening direction of the tailgate. In such cases, damage to the tailgate and injury to pedestrians may occur.

In the tailgate open section between the closed state of the tailgate (e.g., 0° open angle) and the first open angle, the user may arbitrarily unlock the checker arm and checker assembly.

In such cases, when attempting to close the tailgate again, the locking of the checker arm and checker assembly may become impossible due to insufficient relative working power of the checker arm and checker assembly. This may result in the tailgate not being able to open at an adjustable angle disclosure

### SUMMARY

The present disclosure attempts to provide a tailgate opening/closing adjustment device for a vehicle that enables smooth locking and unlocking of the tailgate throughout the entire opening/closing range of the tailgate.

According to an one or more aspects of the presentation disclosure, an apparatus of a vehicle may comprise a tailgate rotatably mounted on a rear body structure of the vehicle; a checker arm mounted on the rear body structure and slidable along a rotation trajectory of the tailgate, wherein the checker arm comprises a locking pin; a checker holder mounted on the tailgate; and a checker lever pivotally installed on the checker holder to lock and unlock the locking pin.

The checker lever may be configured to rotate, by a manual operation, in a lever unlocking direction to unlock the locking pin, and based on the tailgate being opened with the locking pin locked, the checker lever may be configured to receive force from the locking pin in a direction that is opposite to the lever unlocking direction and restrain the locking pin.

The checker lever may be configured to rotate, by a manual operation, in a lever unlocking direction to unlock the locking pin, and the checker lever may be configured to, based on the tailgate being closed, rotate in the lever unlocking direction by the locking pin so that the locking pin locks the checker lever.

The apparatus may further comprise a checker spring mounted between the checker holder and the checker lever.

The checker lever may comprise cam lobes formed on sides of the checker lever, and wherein the cam lobes are configured to make cam contact with the locking pin.

The checker lever may comprise a lever rib formed on a side of the checker lever, and a pin locking groove formed on the side of the checker lever by the lever rib. At least one of the cam lobes may protrude from the lever rib.

The checker holder may be configured to be pivotally connected to the checker lever via a pivot pin by placing the checker lever between opposing sides of the checker holder.

The checker holder may comprise guide ribs facing each other, and wherein a pin support groove is formed in the checker holder between the guide ribs. At least one of the cam lobes may be disposed between the guide ribs.

The guide ribs may comprise: a first guide rib having a first round section formed adjacent to a sliding trajectory of the checker arm, and a second guide rib having a second round section formed in a position corresponding to the first round section.

The checker lever may comprise a lever handle that is coupled to the

checker lever to enable a manual operation and the first guide rib may be formed by a projector portion that extends in a curved manner to a position corresponding to the lever handle.

The second guide rib may comprise a pin stopping portion connected to the second round section.

At least one of the cam lobes comprises: a first cam follower configured to, based on the tailgate being closed, make cam contact with the locking pin so that the checker lever rotates in a lever unlocking direction by the locking pin, and a second cam follower configured to make cam contact with the locking pin so that the checker lever is forced, based on the tailgate being opened and by the locking pin, in a direction opposite to the lever unlocking direction.

The checker holder may further comprise a damping member mounted in the pin support groove and secured to the pin support groove by the checker lever. The checker holder may further comprise a damper cover member coupled to the pivot pin on the checker holder. The damper cover member may be fixed to a fixing hole formed on the checker holder.

The checker spring may be mounted on a spring support pin fixed to the checker lever, and wherein the checker spring is supported on a spring support portion formed on the checker holder. The tailgate may comprise a twin swing tailgate.

According to an one or more aspects of the presentation disclosure, an apparatus of a vehicle may comprise a tailgate rotatably mounted on a rear body structure of the vehicle by a hinge; a checker arm mounted on the rear body

structure and extending along a rotation trajectory of the tailgate, wherein the checker arm is slidable relative to the rear body structure, and wherein the checker arm comprises a locking pin; a checker holder fixed to the tailgate and positioned to receive the locking pin during opening and closing of the tailgate; a checker lever pivotally supported by the checker holder and comprising a pin locking groove configured to engage the locking pin; and a spring connected between the checker holder and the checker lever, wherein the checker lever is configured to: engage the locking pin to restrain opening of the tailgate at an intermediate open angle, disengage from the locking pin based on manual rotation of the checker lever, and automatically re-engage the locking pin during closing movement of the tailgate. The checker lever may comprise cam lobes formed on sides of the checker lever, and wherein the cam lobes are configured to make cam contact with the locking pin during opening and closing of the tailgate.

Additional example features of the apparatuses are further described in the detailed description of the present disclosure with reference to one or more exemplary figures.

In addition, any effects that can be obtained or expected from the disclosed example are disclosed directly or implicitly in the detailed description of the disclosed example. That is, various effects expected according to the disclosed example will be disclosed in the detailed description that follows.

### BRIEF DESCRIPTION OF THE DRAWINGS

The disclosed examples of this specification may be better understood by

reference to the following description taken in conjunction with the accompanying drawings, in which like reference numerals designate identical or functionally similar elements.

FIG. 1A, FIG. 1B, FIG. 1C, FIG. 2A, FIG. 2B, FIG. 3A, and FIG. 3B are drawings showing an example of operation of a tailgate opening/closing adjustment device for a vehicle according to the disclosed example.

FIG. 2A, FIG. 2B, FIG. 3A, FIG. 3B, FIG. 4A, FIG. 4B, FIG. 5A, and FIG. 5B are perspective views showing a tailgate opening/closing adjustment device for a vehicle according to the disclosed example.

FIG. 6 is a partially exploded perspective view showing a tailgate opening/closing adjustment device for a vehicle according to the disclosed example.

FIG. 7 and FIG. 8 are side views showing a tailgate opening/closing adjustment device for a vehicle according to the disclosed example.

FIG. 9A and FIG. 9B are side views showing the operation of a tailgate opening/closing adjustment device for a vehicle according to the disclosed example.

FIG. 10A and FIG. 10B are perspective views showing a checker lever applied to a tailgate opening/closing adjustment device for a vehicle according to the disclosed example.

FIG. 11 is a side view showing a checker lever applied to a tailgate opening/closing adjustment device for a vehicle according to the disclosed example.

FIG. 12A and FIG. 12B are perspective views showing a checker holder applied to a tailgate opening/closing adjustment device for a vehicle according to the disclosed example.

FIG. 13 is a side view showing a checker holder applied to a tailgate opening/closing adjustment device for a vehicle according to the disclosed example.

FIG. 14 is a drawing showing a lever operation blocking structure of a checker holder applied to a tailgate opening/closing adjustment device for a vehicle according to the disclosed example.

FIG. 15A, FIG. 15B, FIG. 15C, FIG. 16A, FIG. 16B, FIG. 16C, FIG. 17A, FIG. 17B, FIG. 17C, FIG. 17D, FIG. 18A, and FIG. 18B are drawings for explaining the operation of a tailgate opening/closing adjustment device for a vehicle according to the disclosed example.

FIG. 19A, FIG. 19B, FIG. 20A, FIG. 20B, and FIG. 21 are drawings showing a tailgate opening/closing adjustment device for comparison.

The drawings referenced above are not necessarily drawn to scale but should be understood as presenting simplified representations of various preferred features that illustrate the basic principles of the disclosed examples. For example, certain design features of the disclosed examples, including specific dimensions, direction, position, and shape, will be determined in part by the intended application and usage environment.

### DETAILED DESCRIPTION

Hereinafter, with reference to the attached drawings, examples of the

present disclosure will be described in detail so that a person having ordinary skill in the art to which the present disclosure pertains can easily practice the present disclosure. As those skilled in the art would realize, the described examples may be modified in various ways, all without departing from the spirit or scope of the present disclosure.

The terminology used herein is for the purpose of describing particular examples only and is not intended to limit the present disclosure. As used herein, the singular forms are intended to include the plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term 'and/or' includes all combinations of one or more of the associated listed items.

In this specification, the term ‘connected’ indicates a physical relationship between two components where the components are directly connected to each other by welding, SPR (Self Piercing Rivet), FDS (Flow Drill Screw), structural adhesive, etc., or indirectly connected through one or more intermediate components.

As used herein, 'vehicle', 'vehicular', 'automotive' or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources).

According to the present disclosure, a vehicle may include a tailgate opening and closing adjustment device that helps the tailgate move safely and smoothly. The tailgate is configured to open to a limited angle and remains held in place so that it does not suddenly swing open due to wind, gravity, or contact with cargo. The device includes a sliding arm connected to the vehicle body, a pin provided on the sliding arm, and a lever mounted on the tailgate that automatically engages the pin to hold the tailgate at a desired open position. When a user wants to open the tailgate further, the user may intentionally operate a handle to release the pin from the lever, allowing the tailgate to open to a wider angle. When the tailgate is closed again, the pin is guided back into engagement with the lever and is automatically re-locked without requiring additional user action. As a result, the tailgate may be opened and closed in a controlled manner, while reducing the risk of sudden movement, damage to the tailgate, or injury to nearby persons.

Hereinafter, examples of the present disclosure will be described in detail with reference to the attached drawings.

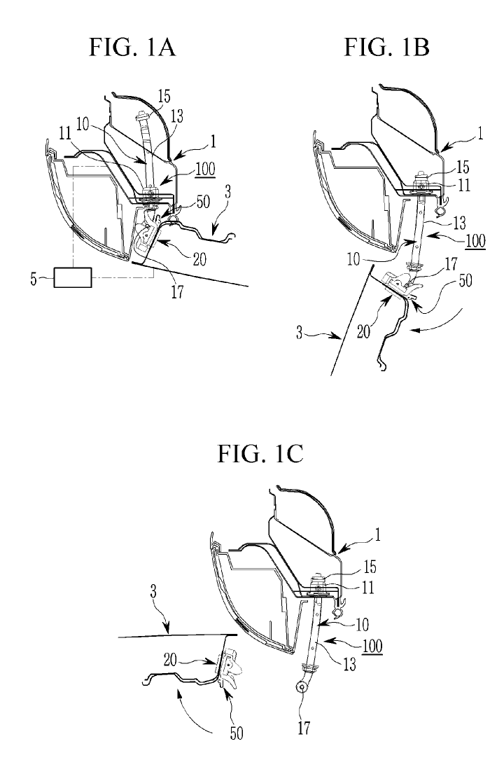

FIG. 1A to FIG. 3C are drawings showing an example of operation of a tailgate opening/closing adjustment device for a vehicle according to the disclosed example.

Referring to FIG. 1A to FIG. 3C, a tailgate opening/closing adjustment device 100 for a vehicle according to the disclosed example is configured to adjust the opening angle of at least one tailgate 3 mounted on a rear vehicle body 1 of the vehicle (e.g., controlling a limited opening angle, a full opening angle, or an intermediate holding position, etc.).

The vehicle may be, for example, a van vehicle with a cabin in the front and a cargo room in the rear (e.g., a commercial van, a cargo van, or a passenger van, etc.). The vehicle to which the tailgate opening/closing adjustment device 100 according to the disclosed example may be applied may be, for example, a purpose-based mobility vehicle (Purpose Built Vehicle: PBV) of various vehicle types (e.g., a logistics vehicle, a service vehicle, or a customized mobility platform, etc.). The PBV may be, for example, a hailing vehicle for transporting occupants, a delivery vehicle for transporting goods, or a special vehicle such as an ambulance (e.g., an emergency response vehicle, a mobile clinic vehicle, or a service support vehicle, etc.).

At least one tailgate 3 may be mounted at the rear of the vehicle to open and close the cargo room (e.g., to allow loading, unloading, or access to stored items, etc.). The tailgate 3 may include, for example, a twin swing tailgate 3 that is rotatably mounted in a hinged manner on the rear vehicle body 1 (e.g., a left-side swing door and a right-side swing door, etc.). For ease of understanding, the twin swing tailgate 3 is referred to as ‘tailgate 3’ below.

The tailgate 3 may be rotatably mounted on the rear pillar of the rear vehicle body 1 via a hinge 5 (e.g., a metal hinge, a reinforced hinge, or a multi- axis hinge, etc.). The configuration and operation of the tailgate 3, which may be opened and closed via the hinge 5, are obvious to those skilled in the art, and thus a detailed description thereof is omitted.

In this specification, an end of a component (e.g., one end or another end, etc.) denotes an end of a component in any one direction, and an end portion of the component (e.g., one end portion or another end portion, etc.) denotes a portion of a component that includes that end.

The tailgate opening/closing adjustment device 100 for a vehicle according to the disclosed example may be connected to the rear vehicle body 1 and the tailgate 3 (e.g., via a checker arm, a bracket, or a mounting structure, etc.).

The tailgate opening/closing adjustment device 100 for a vehicle according to the disclosed example selectively locks and unlocks the tailgate 3 to the rear vehicle body 1, and may adjust the opening/closing of the tailgate 3 to various opening angles (e.g., holding the tailgate at a predetermined angle, releasing the tailgate for further opening, or automatically re-locking during closing, etc.).

The various open angles may include, for example, a closed state of the tailgate 3 of 0° as shown in FIG. 1A, an open state of tailgate 3 with a first-stage opening angle of 90-95° as shown in FIG. 1B, and an open state of tailgate 3 with a second-stage opening angle of 180° as shown in FIG. 1C (e.g., a partially open position for limited access, a fully open position for loading, or an intermediate stop position, etc.).

The tailgate opening/closing adjustment device 100 for a vehicle according to the disclosed example provides a structure that may smoothly perform locking and unlocking of the tailgate 3 throughout the entire opening/closing range of the tailgate 3 (e.g., during initial opening, during full opening, or during closing movement, etc.).

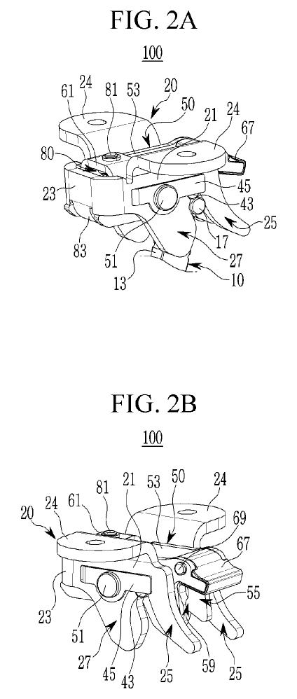

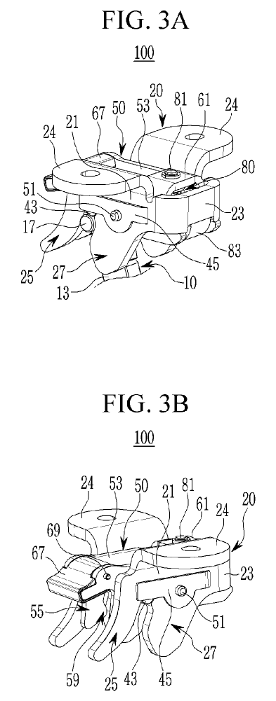

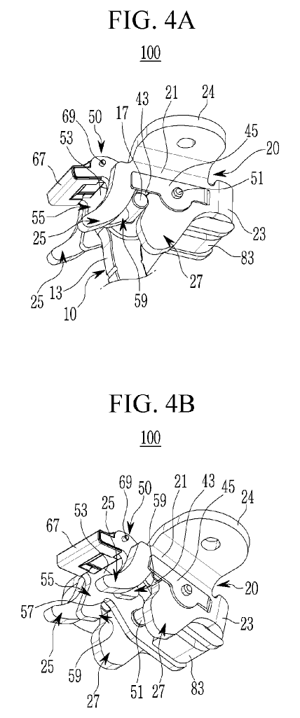

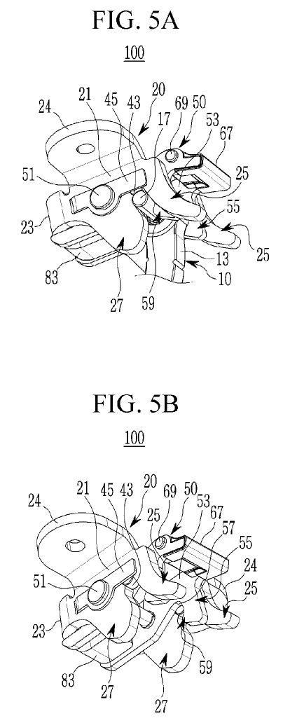

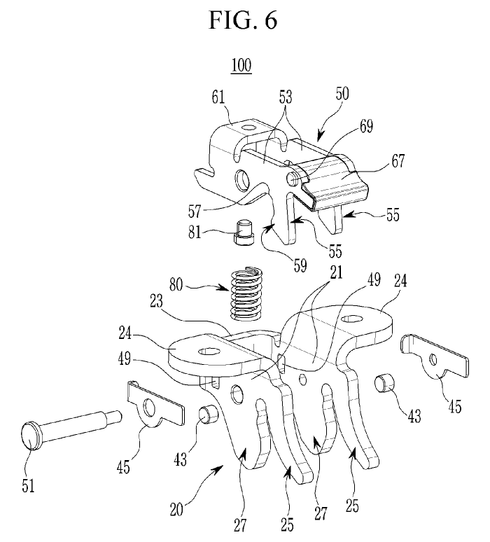

FIG. 2A to FIG. 5B are perspective views showing a tailgate opening/closing adjustment device for a vehicle according to the disclosed example (e.g., views showing locked and unlocked states, etc.), and FIG. 6 is a partially exploded perspective view showing a tailgate opening/closing adjustment device for a vehicle according to the disclosed example (e.g., views separating main components for clarity, etc.).

Referring to FIG. 1 to FIG. 6, the tailgate opening/closing adjustment device 100 for a vehicle according to the disclosed example may include a checker arm 10, a checker holder 20, a checker lever 50, and a checker spring 80 (e.g., mechanical components cooperating to control tailgate movement, etc.).

In the disclosed example, the checker arm 10 supports the opening and closing rotation of the tailgate 3 and is configured to determine the opening angle of the tailgate 3 (e.g., a limited opening angle, a full opening angle, or an intermediate holding angle, etc.).

The checker arm 10 may be slidably connected to a checker mounting member 11 mounted on the rear vehicle body 1 (e.g., a bracket, a guide rail, or an integrated mounting structure, etc.). The checker mounting member 11 may be connected to the rear vehicle body 1 (e.g., by welding, fastening, or integral formation, etc.).

The checker arm 10 may be slidably connected to the checker mounting member 11 along the rotation trajectory of the tailgate 3 (e.g., following an arc-shaped path corresponding to tailgate rotation, etc.).

The checker arm 10 may include an arm body 13, a checker stopper 15, and a locking pin 17 (e.g., structural portions configured for guidance, retention, and locking, etc.).

The arm body 13 may be provided with a curved shape along the rotation trajectory of the tailgate 3 (e.g., an arc-shaped or partially curved profile, etc.). The arm body 13 may be provided in a form having thick sections and thin sections, as will be apparent to a person skilled in the art (e.g., portions reinforced for strength and portions reduced for weight or clearance, etc.).

The checker stopper 15 is configured to prevent the arm body 13 from disengaging through the checker mounting member 11 (e.g., to limit excessive withdrawal or separation, etc.). The checker stopper 15 may be connected to one end of the arm body 13.

The locking pin 17 is configured to selectively lock and unlock with the checker lever 50 described later (e.g., to hold or release the tailgate at a specific opening angle, etc.) and may be connected to the other end of the arm body 13 (e.g., by press-fitting or integral formation, etc.).

The arm body 13 may enter the interior of the rear vehicle body 1 through the checker mounting member 11 when the tailgate 3 is closed.

The arm body 13 may be drawn out from the interior toward the exterior of the rear vehicle body 1 via the checker mounting member 11 when the tailgate 3 is opened at the first-stage opening angle and the second-stage opening angle (e.g., during partial opening or full opening, etc.). The arm body 13 may be kept in a motion-restricted state on the checker mounting member 11 by the checker stopper 15 (e.g., to prevent complete separation, etc.).

The checker holder 20 supports the checker lever 50, which will be described later, and is configured to support the locking pin 17, which is locked and unlocked by the checker lever 50 (e.g., by providing a mounting and engagement structure, etc.).

The checker holder 20 may be mounted on the tailgate 3 at a position corresponding to the locking pin 17 of the checker arm 10 (e.g., such that the locking pin is aligned with the checker lever, etc.).

The checker lever 50 is configured to selectively lock and unlock the locking pin 17 of the checker arm 10 (e.g., to control movement of the tailgate, etc.).

The checker lever 50 may be pivotally installed on the checker holder 20 via a pivot pin 51 (e.g., to allow rotational movement about a pivot axis, etc.).

FIG. 2A, FIG. 3A, FIG. 4A, and FIG. 5A illustrate a state in which the locking pin 17 is locked by the checker lever 50 and the checker holder 20 (e.g., a state preventing further opening, etc.). FIG. 2B, FIG. 3B, FIG. 4B, and FIG. 5B illustrate a state in which the locking pin 17 is unlocked by the checker lever 50 and the checker holder 20 (e.g., a state allowing rotation of the tailgate, etc.).

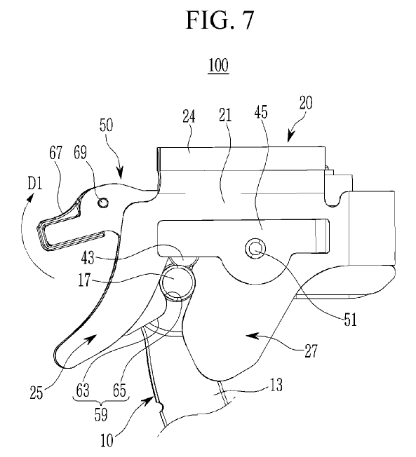

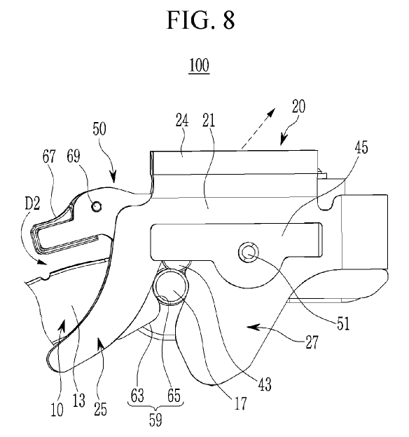

FIG. 7 and FIG. 8 are side views showing a tailgate opening/closing adjustment device for a vehicle according to the disclosed example (e.g., views emphasizing lever movement and pin interaction, etc.).

As shown in FIG. 7, a user may unlock the locking pin 17 of the checker arm 10 by rotating the checker lever 50 in the lever unlocking direction D1 (e.g., by pulling or pushing a lever handle, etc.).

The lever unlocking direction D1 may be defined as the tailgate opening direction of checker lever 50 (e.g., a direction corresponding to releasing engagement, etc.). Also, the lever unlocking direction D1 may be defined as a direction in which the checker lever 50 and the locking pin 17 may be unlocked by the user's operation, i.e., a direction in which the checker lever 50 and checker arm 10 may be separated (e.g., disengaged from each other, etc.).

The user's manipulation may be arbitrary within the range between the full closing angle of the tailgate 3 and the first-stage opening angle (e.g., during initial opening movement, etc.). Additionally, the user's operation may be performed when tailgate 3 is in an open state at the first-stage opening angle, and when tailgate 3 is opened at the second-stage opening angle (e.g., during partial or full opening, etc.).

When the user rotates the checker lever 50 in the lever unlocking direction D1, the locking pin 17 is separated from the checker lever 50, allowing the tailgate 3 to be rotated (e.g., toward a larger opening angle, etc.).

As shown in FIG. 8, when the tailgate 3 is opened while the checker lever 50 is locking the locking pin 17 of the checker arm 10, due to the inertia of the tailgate 3 (e.g., inertial force generated by sudden opening, wind load, or cargo weight shift, etc.), the checker lever 50 is forced in the direction D2 opposite to the lever unlocking direction D1, and may lock the locking pin 17.

In this case, the tailgate opening may be defined as the case where the tailgate 3 is in the open state at the first-stage opening angle and an external force is applied in the opening direction of tailgate 3 (e.g., wind pressure, gravitational force, or user-applied force, etc.).

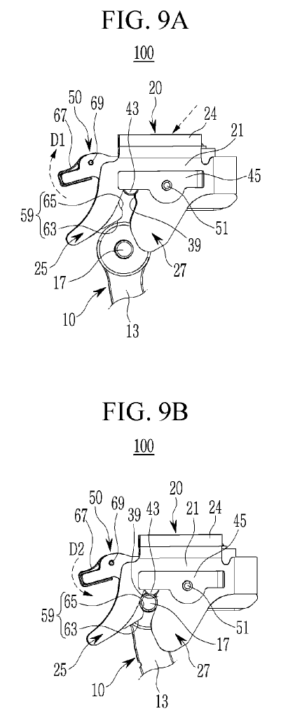

FIG. 9A and FIG. 9B are side views showing the operation of a tailgate opening/closing adjustment device for a vehicle according to the disclosed example (e.g., showing cam-driven interaction between the locking pin and checker lever, etc.).

Referring to FIG. 9A, the checker lever 50 may rotate in the lever unlocking direction D1 by the locking pin 17 of the checker arm 10 when the tailgate is closed, thereby locking the locking pin 17, and as shown in FIG. 9B, the checker lever 50 may rotate in the opposite direction D2 to lock the locking pin 17 (e.g., to resist unintended unlocking during opening movement, etc.).

Here, tailgate closing may be defined as the case where the opening angle of tailgate 3 changes from the second-stage opening angle to the first-stage opening angle (e.g., during partial closing before full closure, etc.).

The configuration of the checker holder 20 and checker lever 50 described above will be described in detail (e.g., with reference to lever geometry and cam structures, etc.).

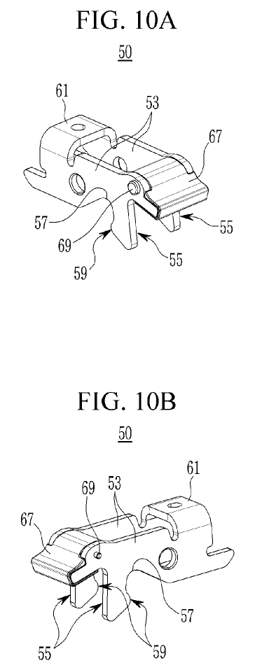

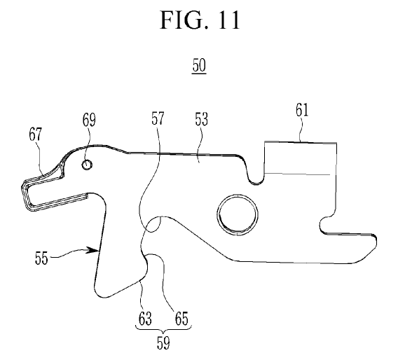

FIG. 10A and FIG. 10B are perspective views showing a checker lever applied to a tailgate opening/closing adjustment device for a vehicle according to the disclosed example (e.g., showing lever ribs, cam lobes, and locking grooves, etc.), and FIG. 11 is a side view showing a checker lever applied to a tailgate opening/closing adjustment device for a vehicle according to the disclosed example.

Referring to FIG. 1 to FIG. 11, in the disclosed example, the checker lever 50 may include a lever rib 55 formed on both lever sides 53, a pin locking groove 57 and a cam lobe 59.

The lever side 53 is formed on each side of the checker lever 50 and may be connected through a lever side connection portion 61 (e.g., a bridge portion or reinforcing connector, etc.).

The lever rib 55 is configured to lock and unlock the locking pin 17 of the checker arm 10 to the lever side 53 (e.g., by engaging or releasing the locking pin, etc.).

The lever rib 55 may be formed at the opposite end (e.g., free end) of the end (e.g., connected end) connected by the lever side connection portion 61 at the lever side 53.

For example, the lever rib 55 may be formed in the shape of a leg at the free end of the lever side 53 (e.g., an elongated rib or protruding leg structure, etc.). The lever rib 55 may be formed longer than the height of the connecting end of lever side 53, with reference to the drawing (e.g., to ensure reliable engagement with the locking pin, etc.).

The pin locking groove 57 may be formed between the connecting end and the free end of the lever side 53 by the lever rib 55 to lock the locking pin 17 of the checker arm 10 (e.g., by receiving and retaining the locking pin, etc.).

The cam lob 59 is configured to make cam contact with the locking pin 17 when locking or unlocking the locking pin 17 with respect to the pin locking groove 57 (e.g., to guide rotation of the checker lever, etc.).

The cam lob 59 may be formed on the lever rib 55. The cam lob 59 may be formed to protrude from the lever rib 55 toward the connecting end of the lever side 53 (e.g., in a direction facing the locking pin, etc.). In one example, the cam lob 59 may extend from the lever rib 55 in a protruded shape (e.g., a triangular rib shape, a curved rib shape, or a stepped rib shape, etc.).

The cam lobe 59 may include a first cam follower 63 and a second cam follower 65 (e.g., cam surfaces having different inclinations, etc.).

The first cam follower 63 may be formed on the lower part of the cam lob 59 with reference to the drawing (e.g., a lower inclined cam surface, etc.).

The first cam follower 63, as shown in FIG. 9A and FIG. 9B, may come into cam contact with the locking pin 17 so that when the tailgate is closed, the checker lever 50 is rotated in the lever unlocking direction D1 by the locking pin 17 (e.g., to allow re-engagement during closing, etc.).

The second cam follower 65 is formed on top of the cam lob 59 with reference to the drawing and may be connected to the first cam follower 63 (e.g., via a continuous cam surface, etc.).

The second cam follower 65 may come into cam contact with the locking pin 17 so that when the tailgate 3 is opened by its own weight or external force, the checker lever 50 may be forced by the locking pin 17 in the opposite direction D2 to the lever unlocking direction D1, thereby restraining the locking pin 17 (e.g., to prevent unintended unlocking, etc.).

The checker lever 50 according to the disclosed example may include a lever handle 67 (e.g., a grip portion or manipulation tab, etc.).

The lever handle 67, as shown in FIG. 7, is configured to rotate the checker lever 50 in the lever unlocking direction D1 by the user's operation (e.g., pulling, pushing, or lifting motion, etc.).

The lever handle 67 may be connected to the free end of the lever side 53 to allow user manipulation (e.g., manual actuation, etc.). The lever handle 67 may be fixed to the free end of the lever side 53 by means of a fixing pin 69 (e.g., a rivet, a fastener, or a press-fit pin, etc.).

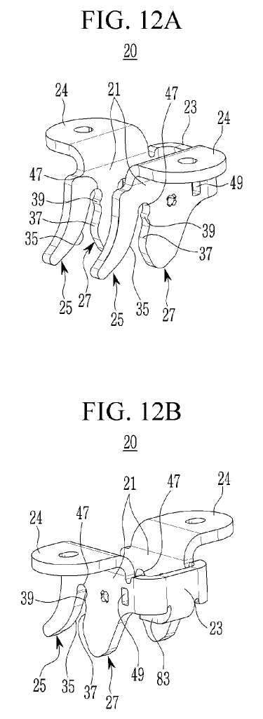

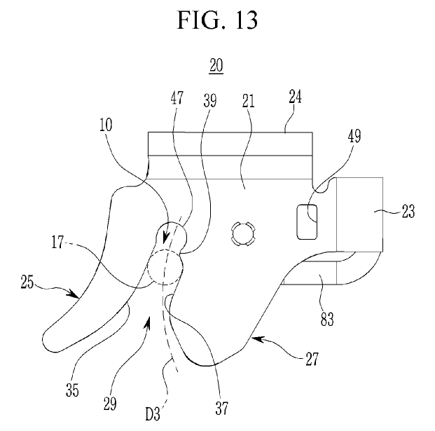

FIG. 12A and FIG. 12B are perspective views showing a checker holder applied to a tailgate opening/closing adjustment device for a vehicle according to the disclosed example (e.g., views showing holder geometry and rib arrangement, etc.), and FIG. 13 is a side view showing a checker holder applied to a tailgate opening/closing adjustment device for a vehicle according to the disclosed example.

Referring to FIG. 1 to FIG. 13, in the disclosed example, the checker holder 20 may include holder sides 21 on both sides (e.g., opposing side walls supporting internal components, etc.).

The holder side 21 is formed on each side of the checker holder 20 and may be connected through a holder side connection portion 23 (e.g., a bridge portion or reinforcing connector, etc.).

The checker holder 20 may be pivotally connected to the lever side 53 of the checker lever 50 by placing the checker lever 50 between the holder sides 21 through the pivot pin 51. That is, the checker lever 50 may be pivotally rotatably mounted on the checker holder 20 via the pivot pin 51 (e.g., to allow rotational movement about a pivot axis, etc.).

The checker holder 20 may include guide ribs 25 and 27 formed on both holder sides 21 (e.g., ribs protruding inward toward the checker lever, etc.).

The guide ribs 25 and 27 are configured to guide the locking pin 17 when locking and unlocking the locking pin 17 with respect to the checker lever 50 (e.g., during manual unlocking or automatic re-locking, etc.).

The guide ribs 25 and 27 are configured to guide the locking pin 17 to the cam lob 59 of the checker lever 50 when the tailgate is closed and when the tailgate is opened (e.g., to ensure proper cam contact, etc.).

The guide ribs 25 and 27 may be arranged facing each other with a pin support groove 29 formed in the holder side 21 between them (e.g., a recessed groove receiving the locking pin, etc.).

The guide ribs 25 and 27 may be formed between the end connected by the holder side connection portion 23 (e.g., a connection end) and the opposite end (e.g., a free end) on the holder side 21.

For example, the guide ribs 25 and 27 may be formed in a leg shape (e.g., elongated rib structures, etc.). The guide ribs 25 and 27 may be formed longer than the height of the connecting end with reference to the drawing (e.g., to improve guidance and retention, etc.).

The pin support groove 29 is configured to support the locking pin 17, which locks and unlocks the checker lever 50 (e.g., by receiving and retaining the locking pin, etc.). The pin support groove 29 may be formed between the guide ribs 25 and 27.

The guide ribs 25 and 27 may include a first guide rib 25 and a second guide rib 27 in the disclosed example (e.g., ribs having different functional shapes, etc.).

The first guide rib 25 may be formed at the free end of the holder side 21. The first guide rib 25 may include a first round section 35 formed close to a sliding trajectory D3 of the checker arm 10 (e.g., to guide smooth entry of the locking pin, etc.).

The second guide rib 27 may be formed between the connecting end and the free end of the holder side 21. The second guide rib 27 may include a second round section 37 formed at a position corresponding to the first round section 35 of the first guide rib 25 (e.g., to provide symmetrical guidance, etc.).

The second guide rib 27 may further include a pin stopping portion 39 connected to the second round section 37. The pin stopping portion 39 may be formed in a groove shape connected to the second round section 37 to prevent sliding of the checker arm 10 (e.g., by mechanically stopping further movement, etc.).

The pin stopping portion 39 stops the locking pin 17 when the tailgate is closed as shown in FIG. 9A and FIG. 9B and may prevent the sliding of the checker arm 10 by engaging with the locking pin 17 (e.g., to maintain a locked state, etc.).

As shown in FIG. 7 to FIG. 9B, the cam lob 59 of the checker lever 50 may be positioned between the first guide rib 25 and the second guide rib 27 (e.g., to allow cam-guided interaction, etc.).

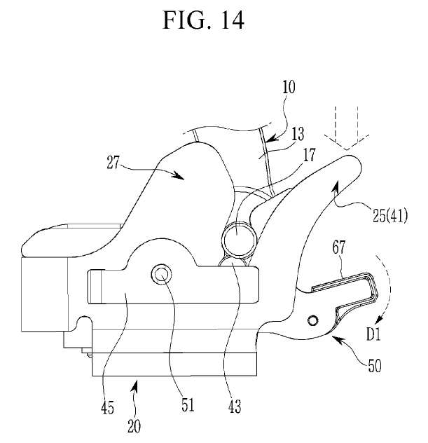

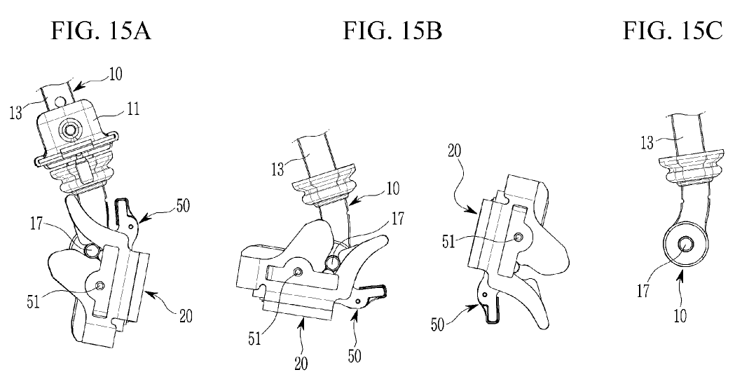

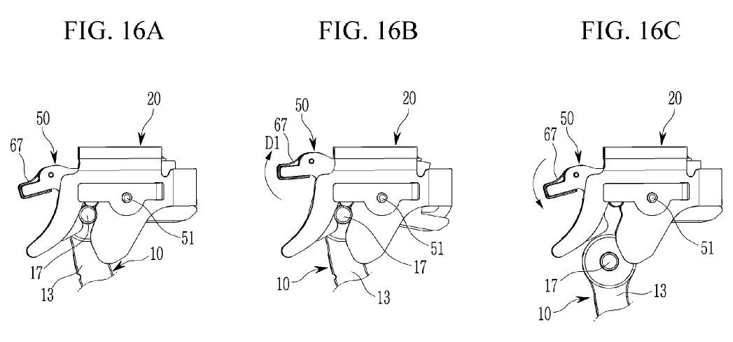

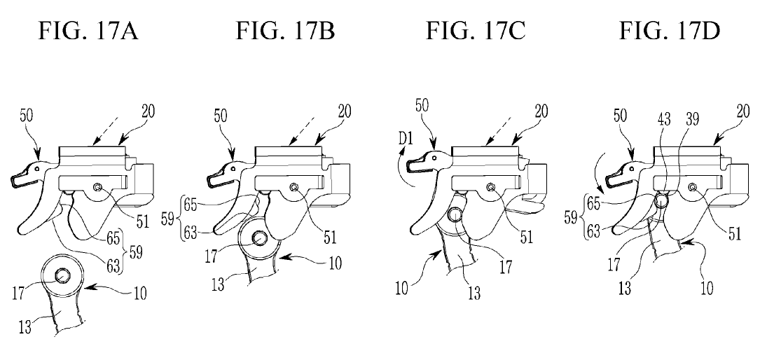

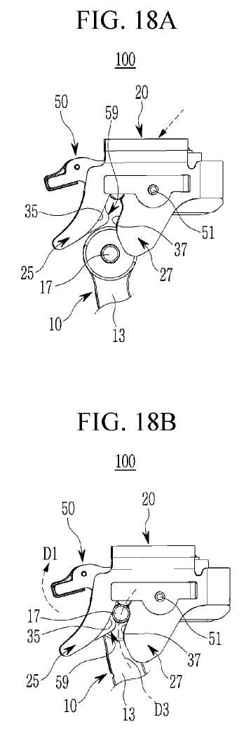

FIG. 14 is a drawing showing a lever operation blocking structure of a checker holder applied to a tailgate opening/closing adjustment device for a vehicle according to the disclosed example (e.g., a structure preventing unintended lever actuation, etc.).

The first guide rib 25 may be formed as a projector portion 41 that is curved and extended to a position corresponding to the lever handle 67, as shown in FIG. 14 (e.g., a protruding shield portion, etc.).

The projector portion 41 is configured to prevent the checker lever 50 from unintentionally rotating in the lever unlocking direction D1 due to baggage, etc., when the tailgate 3 is in an open state at the first-stage opening angle (e.g., contact with cargo or tools, etc.).

In the drawing, reference numeral 24 represents an engage rib. The engage rib 24 extends from the holder side 21 and may be engaged to the tailgate 3 by a fastening member including bolts and nuts (e.g., screws, rivets, or other fasteners, etc.).

Referring to FIG. 2A to FIG. 6, the checker holder 20 according to the disclosed example may further include a damping member 43 and a damper cover member 45 (e.g., components for noise and vibration reduction, etc.).

The damping member 43 is configured to reduce contact noise generated when the checker arm 10 contacts the checker holder 20 and the checker lever 50 (e.g., impact noise or vibration noise, etc.).

The damping member 43 may be mounted in the pin support groove 29 between the first guide rib 25 and the second guide rib 27. The damping member 43 may be mounted on a damper mount portion 47 provided in the pin support groove 29 (see FIG. 13).

The damping member 43 may be fixed to the damper mount portion 47 of the pin support groove 29 by the lever side 53 of the checker lever 50 (e.g., retained by lever contact, etc.). The damping member 43 may be provided as a damping block of, for example, rubber material (e.g., elastomer, synthetic rubber, or polymer, etc.).

The damper cover member 45 is configured to secure the damping member 43. The damper cover member 45 may be connected to the pivot pin 51 on the holder side 21. The damper cover member 45 may be fixed to the fixing hole 49 formed on the holder side 21 (e.g., to prevent detachment, etc.).

Referring to FIG. 2A to 6, in the disclosed example, the checker spring 80 may elastically support the checker lever 50 pivotally connected to the checker holder 20 (e.g., by biasing the checker lever toward a locking position, etc.).

The checker spring 80 may be mounted between the checker holder 20 and the checker lever 50 (e.g., to bias the checker lever toward a locking position, etc.). The checker spring 80 may be mounted on a spring support pin 81 fixed to the lever side connection portion 61 of the checker lever 50 (e.g., a pin or protrusion integrally formed with the lever, etc.).

Additionally, the checker spring 80 may be supported on a spring support portion 83 connected to the holder side 21 of the checker holder 20 (e.g., a recessed seat or bracket portion, etc.).

The checker spring 80 may apply an elastic force to the checker lever 50 in the direction D2 opposite to the lever unlocking direction D1 of the checker lever 50 (e.g., a restoring force biasing the lever toward engagement, etc.). The checker spring 80 may be compressed when the checker lever 50 rotates in the lever unlocking direction D1 (e.g., during manual unlocking, etc.). The checker spring 80 may apply elastic restoring force to the checker lever 50 when compressed (e.g., to automatically return the lever to a locking position, etc.).

Hereinafter, the operation of the tailgate opening/closing adjustment device 100 for a vehicle according to the disclosed example configured as described above will be described in detail with reference to the accompanying drawings (e.g., operational states during opening and closing, etc.).

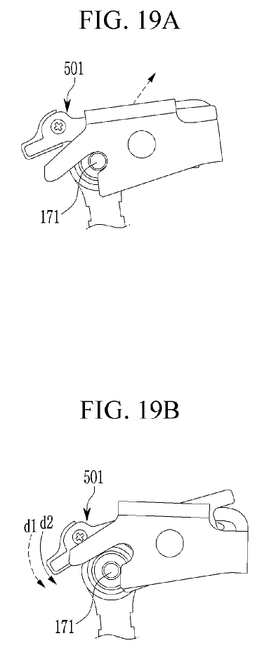

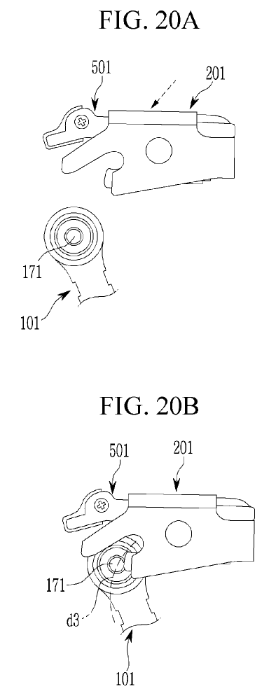

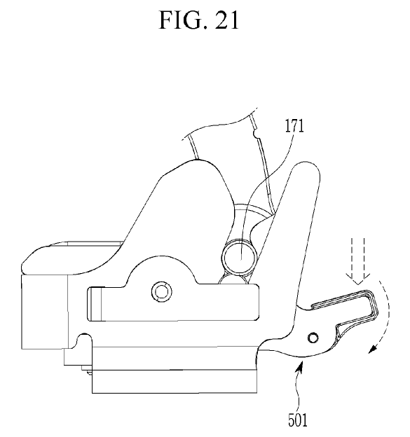

FIG. 15A to FIG. 18B are drawings for explaining the operation of a tailgate opening/closing adjustment device for a vehicle according to the disclosed example (e.g., sequential operational states, etc.), and FIG. 19 to FIG. 21 are drawings showing a tailgate opening/closing adjustment device for comparison (e.g., conventional structures lacking force-direction control, etc.).

Referring to FIG. 1 and FIG. 15A, in the fully closed state S1 of the tailgate 3 relative to the rear vehicle body 1, the checker holder 20 and the checker lever 50 are pivotally connected via the pivot pin 51, and the checker holder 20 is connected to the tailgate 3 (e.g., fixedly mounted to move together with the tailgate, etc.).

The arm body 13 of the checker arm 10 is slidably mounted on the checker mounting member 11 attached to the rear vehicle body 1 (e.g., along a curved guide path, etc.). The locking pin 17 of the checker arm 10 is locked into the pin locking groove 57 of the checker lever 50 (see FIG. 11) via the pin support groove 29 of the checker holder 20 (see FIG. 13) (e.g., establishing a locked state, etc.).

The arm body 13 enters the interior of the rear vehicle body 1 through the checker mounting member 11 in the state where the tailgate 3 is completely closed (e.g., to minimize protrusion, etc.).

Referring to FIG. 15B, the arm body 13 is drawn out to the outside of the rear vehicle body 1 through the checker mounting member 11, with the tailgate 3 in the open state at the first-stage opening angle (e.g., a partially open state, etc.). The arm body 13 is stopped on the checker mounting member 11 by the checker stopper 15 (e.g., to prevent further sliding, etc.).

The assembly of the checker holder 20 and the checker lever 50 may rotate together with the tailgate 3 about the locking pin 17 of the checker arm 10 when the tailgate 3 is opened to the first-stage opening angle (e.g., as an integrated rotating structure, etc.).

When the tailgate 3 opens at the first-stage opening angle, external force due to wind or user may be applied to the tailgate 3 in the opening direction of the tailgate 3 (e.g., wind pressure, pushing force, or load shift, etc.).

When tailgate 3 is in the open state at the first-stage opening angle, external force due to wind, baggage, or user may be applied to tailgate 3 in the opening direction of the tailgate 3 (e.g., accidental pushing or cargo contact, etc.).

As shown in FIG. 8, the locking pin 17, which is locked to the checker lever 50 through the checker holder 20, is in cam contact with the second cam follower 65 of the cam lob 59 of the checker lever 50 (e.g., positioned along a cam surface, etc.).

In this state, when an external force is applied to the tailgate 3 in the opening direction of the tailgate 3, the locking pin 17 pressurizes the second cam follower 65 (e.g., applies a force along the cam surface, etc.).

Therefore, the checker lever 50 may be forced in the direction D2 opposite to the lever unlocking direction D1 to lock the locking pin 17 by the cam action of the locking pin 17 and the second cam follower 65 (e.g., generating a self-locking effect, etc.).

The locking pin 17 is not unlocked from the checker lever 50 by external force, preventing unintentional opening of the tailgate 3 (e.g., during gusts of wind or accidental impacts, etc.). It may prevent damage to tailgate 3 and injury to pedestrians due to sudden opening of tailgate 3 (e.g., in parking or loading environments, etc.).

However, in the case of a comparative example as shown in FIG. 19, FIG. 19A and FIG. 19B, when an external force is applied to the tailgate in the opening direction of the tailgate, a checker lever 501 rotates in the same direction d2 as a lever unlocking direction d1 by a locking pin 171 (e.g., due to lack of opposing cam action, etc.).

In this way, the locking pin 171 is unlocked from the checker lever 501, and the tailgate may be opened unintentionally (e.g., without user intent, etc.). In such cases, the tailgate may be damaged, and pedestrians may be injured (e.g., by sudden swinging motion, etc.).

In the tailgate opening/closing adjustment device for a vehicle according to the disclosed example, as shown in FIG. 15C, the tailgate 3 may be opened from the open state with the first-stage opening angle to a second-stage opening angle of approximately 180° (e.g., a fully open state for loading or unloading, etc.).

With the tailgate 3 in open state at the first-stage opening angle, the user holds the lever handle 67 of the checker lever 50, as shown in FIG. 16A and FIG. 16B, and rotates the checker lever 50 in the lever unlocking direction D1 (e.g., by manual manipulation, etc.). The checker lever 50 compresses the checker spring 80 (see FIG. 6), unlocking the locking pin 17 (e.g., allowing further opening movement, etc.).

As shown in FIG. 16C, when the user opens the tailgate 3, the locking pin 17 disengages from the pin support groove 29 of the checker holder 20 and the pin locking groove 57 of the checker lever 50 (e.g., by manual opening operation, etc.). When the user releases the lever handle 67 while opening tailgate 3, the checker lever 50 returns to its original position by the elastic restoring force of the checker spring 80 (e.g., a spring-biased return motion, etc.).

Therefore, the tailgate 3 may be opened to the second-stage opening angle of approximately 180° by user operation (e.g., a fully open state for loading or unloading, etc.).

When tailgate 3 is closed while the tailgate 3 is open at the second-stage opening angle and switched to the first-stage opening angle, as shown in FIG. 17A, an external force from the user is applied to tailgate 3 in the closing direction of the tailgate 3 (e.g., pushing or pulling force, etc.).

As shown in FIG. 17B, the locking pin 17 of the checker arm 10 enters the pin support groove 29 of the checker holder 20 and the pin locking groove 57 of the checker lever 50. During this process, the locking pin 17 makes cam contact with the first cam follower 63 of the cam lobe 59 of the checker lever 50 (e.g., initial cam-guided engagement, etc.).

As shown in FIG. 17C, the locking pin 17 presses the first cam follower 63 by an external force acting on the tailgate 3 in the closing direction of the tailgate 3 (e.g., a closing force applied by the user, etc.). As the locking pin 17 presses the first cam follower 63, the cam action of the locking pin 17 and the first cam follower 63 causes the checker lever 50 to compress the checker spring 80 and rotate in the lever unlocking direction D1 (e.g., temporary lever rotation during re-locking, etc.).

As shown in FIG. 17D, when the locking pin 17 leaves the first cam follower 63, the checker lever 50 returns to its original position by the elastic restoring force of the checker spring 80 (e.g., automatic lever return, etc.). The locking pin 17 is in cam contact with the second cam follower 65 of the cam lob 59 and is locked into the pin locking groove 57 of the checker lever 50 through the pin support groove 29 of the checker holder 20. The locking pin 17 may be locked to the pin stopping portion 39 of the second guide rib 27 (e.g., to restrict further sliding, etc.).

When the locking pin 17 is locked into the pin locking groove 57 through the pin support groove 29, the damping member 43 may reduce contact noise generated when the locking pin 17 contacts the checker holder 20 and the checker lever 50 (e.g., impact noise or vibration noise, etc.).

The tailgate 3 may be maintained open from the second-stage opening angle to the first-stage opening angle (e.g., a stable partially open state, etc.). The tailgate 3 may also remain fully closed to the rear vehicle body 1 from the first-stage opening angle (e.g., a fully closed and locked state, etc.).

In the interval between the full closing angle of tailgate 3 and the first-stage opening angle, the user may arbitrarily unlock the checker lever 50 and locking pin 17 by rotating the checker lever 50 in the unlocking direction D1 (see FIG. 16) (e.g., to allow further opening, etc.).

The locking pin 17 of the checker arm 10 is positioned between the full closing angle and the first-stage opening angle of the tailgate 3 via the arm body 13 (e.g., along a sliding trajectory, etc.). A thin section of the arm body 13 is positioned on the checker mounting member 11 (e.g., a reduced-thickness portion, etc.).

In this state, as shown in FIG. 18A and FIG. 18B, if the user closes the tailgate 3 and locks the checker lever 50 and locking pin 17 again, the working power of the arm body 13 for the checker lever 50 may be weakened (e.g., due to reduced leverage, etc.).

The checker holder 20 includes the first guide rib 25 having the first round section 35 formed close to the sliding trajectory D3 of the checker arm 10, and the second guide rib 27 having the second round section 37 formed at a position corresponding to the first round section 35 (e.g., symmetric guiding portions, etc.).

Therefore, when the user closes the tailgate 3, the first guide rib 25 and the second guide rib 27 may easily guide the locking pin 17 to the cam lob 59 of the checker lever 50 through the first round section 35 and the second round section 37 (e.g., smooth cam entry guidance, etc.).

Then, referring to FIG. 17A and FIG. 17B, the checker lever 50 overcomes the elastic force of the checker spring 80 by the cam action of the locking pin 17 and the cam lobe 59, and may rotate in the lever unlocking direction D1 (e.g., enabling re-locking, etc.).

Even if the working power of the arm body 13 for the checker lever 50 is weakened, the locking pin 17 may be smoothly locked into the pin locking groove 57 of the checker lever 50 through the pin support groove 29 of the checker holder 20 (e.g., due to the guide rib configuration, etc.).

On the other hand, in the comparative example shown in FIG. 20A and FIG. 20B, in the interval between the full closing angle of the tailgate and the first-stage opening angle, where the user arbitrarily unlocked the locking pin 171 and the checker lever 501, it may be impossible to open and close the tailgate (e.g., due to misalignment, etc.).

To elaborate, the guide section of the checker holder 201 that guides the locking pin 171 to the checker lever 501 is far from the sliding trajectory d3 of the checker arm 101 (e.g., insufficient proximity for guidance, etc.).

Therefore, when the user closes the tailgate and locks the checker lever 501 and locking pin 171, the working power of the checker arm 101 is weak, and the locking pin 171 is not smoothly guided to the checker lever 501, so the checker lever 501 may not be able to overcome the elastic force of the checker spring (not shown) (e.g., due to insufficient cam action, etc.).

As a result, the locking of the locking pin 171 and the checker lever 501 may become impossible because the checker lever 501 cannot rotate due to the locking pin 171 (e.g., mechanical interference, etc.).

In a comparative example as shown in FIG. 21, when the tailgate is opened at the first-stage opening angle, the checker lever 501 may rotate unintentionally due to baggage, etc., and unlock the locking pin 171 (e.g., accidental contact, etc.).

In such cases, the tailgate may suddenly open to the second-stage opening angle (e.g., rapid swinging motion, etc.). Sudden opening of the tailgate may cause damage to the tailgate and cause safety accidents for pedestrians (e.g., impact injuries, etc.).

However, as shown in FIG. 14, in the disclosed example, since the first guide rib 25 of the checker holder 20 is formed with the projector portion 41, the projector portion 41 may prevent baggage or the like from coming into contact with the lever handle 67 of the checker lever 50 (e.g., shielding or blocking contact, etc.).

This prevents the checker lever 50 from unintentionally rotating in the lever unlocking direction D1 due to baggage, etc., when tailgate 3 is in the open state at the first-stage opening angle (e.g., during cargo loading, etc.).

A tailgate opening/closing adjustment device for a vehicle according to the disclosed example that adjusts the opening angle of a tailgate rotatably mounted on a rear vehicle body, the tailgate opening/closing adjustment device may include a checker arm including a locking pin and being installed so as to be slidable along the rotation trajectory of the tailgate on a checker mounting member mounted on the rear vehicle body, a checker holder mounted on the tailgate, and a checker lever pivotally installed on the checker holder to selectively lock and unlock the locking pin.

The checker lever may rotate in the lever unlocking direction by the user's operation, unlocking the locking pin.

When the tailgate is opened with the locking pin locked, the checker lever may receive force in the opposite direction to the lever unlocking direction by the locking pin, thereby restraining the locking pin.

The checker lever may rotate in the lever unlocking direction by the user's operation, unlocking the locking pin and the checker lever may rotate in the lever unlocking direction by the locking pin when the tailgate is closed, and the locking pin locks the lever.

The tailgate opening/closing adjustment device may further include a checker spring mounted between the checker holder and the checker lever.

The checker lever may include cam lobes formed on both lever sides to make cam contact with the locking pin.

The checker lever may include a lever rib formed on the lever side, and a pin locking groove formed on the lever side by the lever rib,

The cam lob may be formed by protruding from the lever rib.

The checker holder may be pivotally connected to the lever side via a pivot pin by placing the checker lever between the holder sides on both sides.

The checker holder may include guide ribs arranged facing each other with a pin support groove formed in the holder side between them.

The cam lob may be disposed between the guide ribs.

The guide ribs may include a first guide rib having a first round section formed close to the sliding trajectory of the checker arm, and a second guide rib having a second round section formed in a position corresponding to the first round section.

The checker lever may include a lever handle that is coupled to the lever side to enable the user to operate.

The first guide rib may be formed by a projector portion that extends in a curved manner to a position corresponding to the lever handle.

The second guide rib may include a pin stopping portion connected to the second round section.

The cam lob may include a first cam follower that makes cam contact with the locking pin so that the checker lever rotates in the lever unlocking direction by the locking pin when the tailgate is closed, and a second cam follower that makes cam contact with the locking pin so that when the tailgate is opened, the checker lever is forced in the direction opposite to the lever unlocking direction by the locking pin.

The checker holder may further include a damping member mounted in the pin support groove between the guide ribs and secured to the pin support groove by the lever side.

The checker holder may further include a damper cover member coupled to the pivot pin on the holder side.

The damper cover member may be fixed to a fixing hole formed on the holder side.

The checker spring may be mounted on a spring support pin fixed to the checker lever and supported on a spring support portion formed on the checker holder.

The tailgate may be a twin swing tailgate.

According to the tailgate opening/closing adjustment device for a vehicle according to the disclosed example, locking and unlocking of the tailgate can be smoothly performed throughout the entire opening and closing range of the tailgate.

According to the tailgate opening/closing adjustment device for a vehicle according to the disclosed example, damage to the tailgate and safety accidents to pedestrians due to sudden opening of the tailgate may be prevented.

While this disclosure has been described in connection with what is presently considered to be practical examples, it is to be understood that the disclosure is not limited to the disclosed examples. On the contrary, it is intended to cover various modifications and equivalent arrangements included within the spirit and scope of the appended claims.

What is claimed is:

1. An apparatus of a vehicle, the apparatus comprising:
a tailgate rotatably mounted on a rear body structure of the vehicle;
a checker arm mounted on the rear body structure and slidable along a rotation trajectory of the tailgate, wherein the checker arm comprises a locking pin;
a checker holder mounted on the tailgate; and
a checker lever pivotally installed on the checker holder to lock and unlock the locking pin.

2. The apparatus of claim 1, wherein:
the checker lever is configured to rotate, by a manual operation, in a lever unlocking direction to unlock the locking pin, and
based on the tailgate being opened with the locking pin locked, the checker lever is configured to receive force from the locking pin in a direction that is opposite to the lever unlocking direction and restrain the locking pin.

3. The apparatus of claim 1, wherein:
the checker lever is configured to rotate, by a manual operation, in a lever unlocking direction to unlock the locking pin, and
the checker lever is configured to, based on the tailgate being closed, rotate in the lever unlocking direction by the locking pin so that the locking pin locks the checker lever.

4. The apparatus of claim 1, further comprising a checker spring mounted between the checker holder and the checker lever.

5. The apparatus of claim 1, wherein the checker lever comprises cam lobes formed on sides of the checker lever, and wherein the cam lobes are configured to make cam contact with the locking pin.

6. The apparatus of claim 5, wherein the checker lever comprises a lever rib formed on a side of the checker lever, and a pin locking groove formed on the side of the checker lever by the lever rib, and
wherein at least one of the cam lobes protrudes from the lever rib.

7. The apparatus of claim 5, wherein the checker holder is configured to be pivotally connected to the checker lever via a pivot pin by placing the checker lever between opposing sides of the checker holder.

8. The apparatus of claim 5, wherein the checker holder comprises guide ribs facing each other, and wherein a pin support groove is formed in the checker holder between the guide ribs.

9. The apparatus of claim 8, wherein at least one of the cam lobes is disposed between the guide ribs.

10. The apparatus of claim 8, wherein the guide ribs comprise:
a first guide rib having a first round section formed adjacent to a sliding trajectory of the checker arm, and
a second guide rib having a second round section formed in a position corresponding to the first round section.

11. The apparatus of claim 10, wherein:
the checker lever comprises a lever handle that is coupled to the checker lever to enable a manual operation; and
the first guide rib is formed by a projector portion that extends in a curved manner to a position corresponding to the lever handle.

12. The apparatus of claim 10, wherein the second guide rib comprises a pin stopping portion connected to the second round section.

13. The apparatus of claim 5, wherein at least one of the cam lobes comprises:
a first cam follower configured to, based on the tailgate being closed, make cam contact with the locking pin so that the checker lever rotates in a lever unlocking direction by the locking pin, and
a second cam follower configured to make cam contact with the locking pin so that the checker lever is forced, based on the tailgate being opened and by the locking pin, in a direction opposite to the lever unlocking direction.

14. The apparatus of claim 8, wherein the checker holder further comprises a damping member mounted in the pin support groove and secured to the pin support groove by the checker lever.

15. The apparatus of claim 7, wherein the checker holder further comprises a damper cover member coupled to the pivot pin on the checker holder.

16. The apparatus of claim 15, wherein the damper cover member is fixed to a fixing hole formed on the checker holder.

17. The apparatus of claim 4, wherein the checker spring is mounted on a spring support pin fixed to the checker lever, and wherein the checker spring is supported on a spring support portion formed on the checker holder.

18. The apparatus of claim 1, wherein the tailgate comprises a twin swing tailgate.

19. An apparatus of a vehicle, the apparatus comprising:
a tailgate rotatably mounted on a rear body structure of the vehicle by a hinge;
a checker arm mounted on the rear body structure and extending along a rotation trajectory of the tailgate, wherein the checker arm is slidable relative to the rear body structure, and wherein the checker arm comprises a locking pin;
a checker holder fixed to the tailgate and positioned to receive the locking pin during opening and closing of the tailgate;
a checker lever pivotally supported by the checker holder and comprising a pin locking groove configured to engage the locking pin; and
a spring connected between the checker holder and the checker lever,
wherein the checker lever is configured to:
engage the locking pin to restrain opening of the tailgate at an intermediate open angle,
disengage from the locking pin based on manual rotation of the checker lever, and
automatically re-engage the locking pin during closing movement of the tailgate.

20. The apparatus of claim 19, wherein the checker lever comprises cam lobes formed on sides of the checker lever, and wherein the cam lobes are configured to make cam contact with the locking pin during opening and closing of the tailgate.
